(19) United States
(12) Patent Application Publication
(10) Pub. No.: US 2007/0021063 A1
(43) Pub. Date: Jan. 25, 2007

(54) System, transmitter, receiver, signal, method, for distributing services

(76) Inventors: Frederik Bleker, Eindhoven (NL); Marnix Claudius Vlot, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/574,366

(22) PCT Filed: Sep. 29, 2004
(86) PCT No.: PCT/IB04/51910

§ 371 Date: Mar. 30, 2006

(30) Foreign Application Priority Data
Oct. 6, 2003 (EP) 03103692.4

(51) Int. Cl. H04B 7/24

(52) U.S. Cl. 455/39

(57) ABSTRACT

A system for distributing a signal carrying a plurality of services, the system comprises: a transmitter for generating numbering information pertaining to the plurality of services, for including the numbering information into the signal, and for transmitting the signal, a receiver for receiving the signal, for retrieving the numbering information from the signal, and for numbering services of the plurality of services in dependence of the numbering information.

The invention relates to a system for distributing a signal carrying a plurality of services.

The invention also relates to a transmitter, a receiver, and a signal for use in such a system.

The invention also relates to a method for distributing, a method for transmitting, and a method for receiving, a signal carrying a plurality of services.

A system as described in the opening paragraph is known from digital networks such as a DVB-T network for the terrestrial and digital distribution of transport streams carrying a plurality of services, e.g. television programs. A network operator broadcasts the services using a transmitter that emits transport streams at a carrier frequency. End-users can experience the broadcasted content by using a receiver that is coupled to the transmitter by a medium through which the broadcast propagates. The receiver tunes to the appropriate carrier frequency to receive the desired transport streams and the services. The end-user typically selects at least one of the plurality of services to experience. The receiver assigns a number to each service for ease-of-reference by the end-user. This number is used in the user interface of the receiver. The receiver may receive signals from several transmitters.

It is a disadvantage of the known systems that the user interface of the receiver is affected by changes in the plurality of services or by changes in the transmitter. The transmitter fading away or not operating normally may cause these changes. The network operators changing the transmitted frequencies or moving the services to another frequency or network may also cause these changes.

Another disadvantage is that the network operators can influence the numbering of the services in the receiver only in a limited way.

It is an object of the present invention to provide for a system for distributing a signal carrying a plurality of services that does not suffer from the abovementioned drawbacks.

This object is realized in that the system for distributing a signal carrying a plurality of services comprises:
a transmitter for generating numbering information pertaining to the plurality of services, for including the numbering information into the signal, and for transmitting the signal,
a receiver for receiving the signal, for retrieving the numbering information from the signal, and for numbering services of the plurality of services in dependence of the numbering information.

By transmitting and receiving the numbering information, the numbering of the services in the receiver can be controlled by the transmitter, i.e. by the network operator controlling the transmitter. The system may comprise or be part of a DVB-T network. The numbering information may pertain to certain aspects of the plurality of services, like a descriptor, a modification, a history, an indicator for a moved service, or an indication on how to number the service. Detailed examples of the information are included further below; see the tables and the respective text. The generation of the numbering information may be under (manual) control of the network operator. Alternatively, the numbering information may be created automatically.

The receiver may be part of a television set, a set top box, or a storage device like a video recorder. The receiver receives the signal carrying the plurality of services and the numbering information. The receiver may be arranged to assign a number to each service received. The receiver may also be arranged to search for services. The receiver is arranged for numbering the services in dependence of the information. The numbering may be modified in response to an event. Examples of such an event are described in detail below. The event may relate to the numbering information being received, an end-user interacting with the receiver, or a reception quality. The numbering of the services may be implemented in software that is executed by a processor in the receiver.

The above object and features of the system, the transmitter, the receiver, the signal, the method, and the computer program product of the present invention will be more apparent from the following description with reference to the drawings.

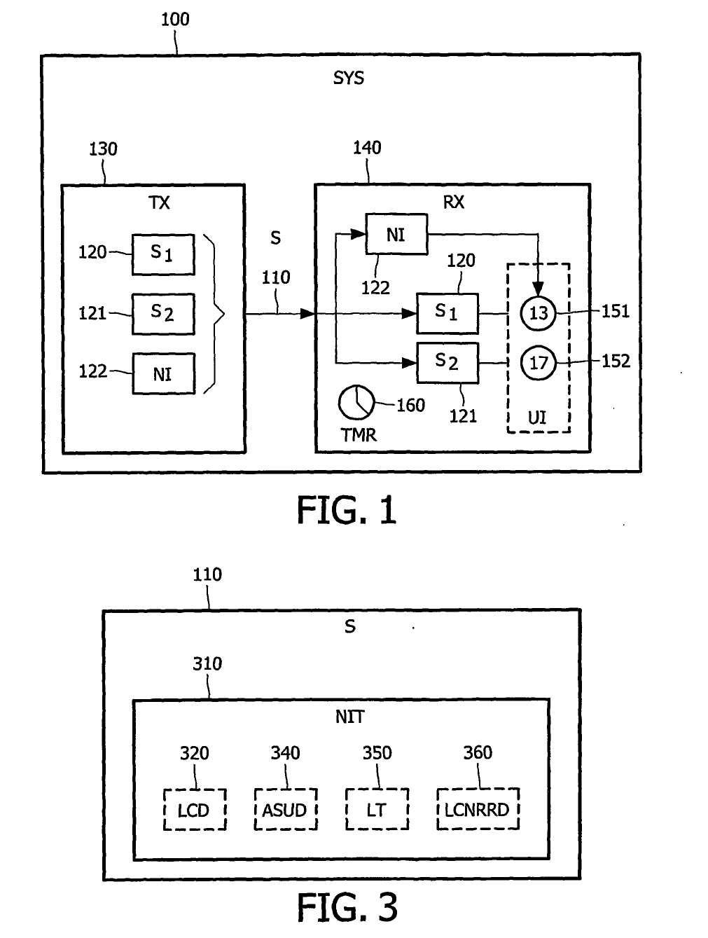

FIG. 1 shows a block diagram of the system 100 for distributing services according to the invention.

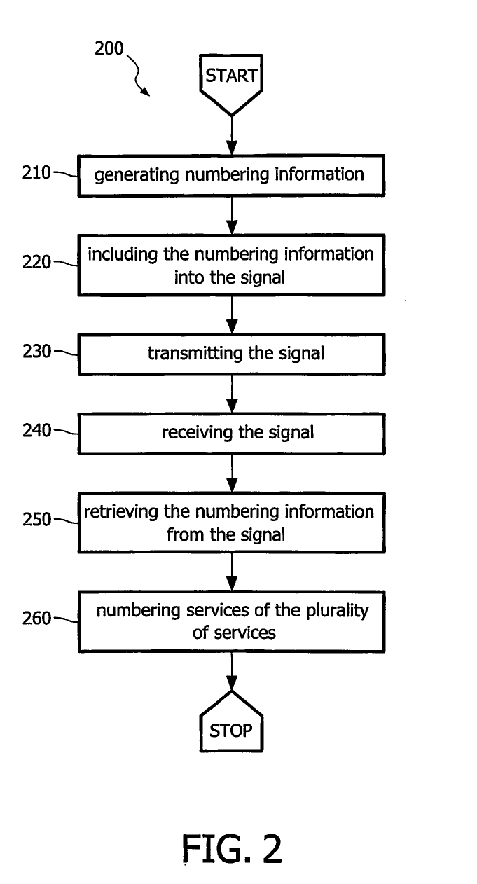

FIG. 2 shows a flowchart of the method 200 for distributing services according to the invention.

FIG. 3 shows an example of a signal 110 according to the invention. Some of the functions or elements in the drawings may be implemented in software, and as such represent software entities, such as software modules or objects.

Digital Terrestrial Television (DTT) networks as specified by DVB-Terrestrial offer a large number of digital television and radio services 120, 121. Over time the networks evolve, offering other services. Also new DTT networks can be introduced. To assist the end user in keeping track of new, moved or deleted services, a DVB-Terrestrial receiver 140 can be equipped with an ‘Automatic Service Update Installation’ function. The ‘Automatic Service Update Installation’ function depends on signaling information such as Service Information (SI) as distributed by DTT networks. The assignment of preset numbers 151, 152 to services 120, 121 is in dependence of the availability of the ‘logical_channel_descriptor’ 320 in the Network Information Table 310, which is part of the distribution 110. This leaves manufacturer specific solutions open, which are sometimes not desired by DTT network operators.

Use of a first descriptor 340 may be used to obtain an improved ‘Automatic Service Update Installation’ function in a DVB-T receiver. The first descriptor 340 may be transmitted in the Network Information Table 310 (NIT). The first descriptor may be called “Automatic service update descriptor” and contains detailed information for DVB-T receivers on how to perform an Automatic Service Update Installation. An example of syntax and semantics of the first descriptor is given further below.

The use of a new linkage_type 350 may be used to signal a service 120, 121 that has moved within a network or that has moved from a network to another network. An example of syntax and semantics of the new linkage_type 350 is given further below.

To give DTT network operators more control on the assignment of preset numbers 151, 152, a second descriptor 360 may be used. The second descriptor 360 comprises a recommendation for receivers 140 on how to assign preset numbers to specific groups of services 120, 121. The second descriptor 360 may be called “LCN reserved range descriptor” The second descriptor may be transmitted in the NIT 310. An example of syntax and semantics of the second descriptor is given further below.

The syntax is based on tuples of a tag, a length and a value.

A DVB-T receiver may automatically update the list of installed services based on service information being broadcast on DVB-T networks. A common understanding between network operators and receiver manufacturers is needed for a reliable automatic update installation feature in DVB-T receivers.

From a receiver point of view an automatic service update installation function needs to detect changes in the service information delivered by the received DVB-T network. This service information may be carried in NIT/actual and may be extended with NIT/other. Also SDT/actual and SDT/other contain service information. Here the focus is on service information carried in NIT/actual.

To be able to describe an automatic service update installation function the concept of a list of installed services in the receiver should be clear. A data model of a list of installed services is described later. This data model is only used as a reference and does not imply an implementation rule.

Triggers

The automatic service update installation function is supposed to execute as a background task in the receiver. This means that it may likely not disturb the viewing experience of the user. Also the user may have no direct control to start a service update installation function.

The service update installation function may be activated by either of the following triggers or a combination thereof:
A new version of NIT/actual 310 is received
The user tunes to a service 120, 121
The receiver 140 is switched to standby
A timer expires 160

An example of a combination is that the function is activated only in response to the timer expiring, while the timer is restarted with every of the other triggers. The following will elaborate upon some triggers.

A New Version of Nit/actual is Received

When the system receives a new version of NIT/actual it can process the data in NIT/actual to automatically update changes in the services provided by the network described by this NIT/actual.

The table below gives an overview which data in NIT/actual is being processed to detect changes in a network.

| | | delivery | frequency | service | |
|---|---|---|---|---|---|
| | TS | system | list | list | LCN |
| | loop | descriptor | descriptor | descriptor | descriptor |
| TS added to network | ● | ∘ | ∘ | ∘ | ∘ |
| TS deleted from network | ● | | | | |
| TS assigned to new frequency in | | ● | ● | | |
| same network | | | | | |
| Service added to the network | | | | ● | ∘ |
| Service removed from the network | | | | ● | ∘ |
| Service relocated on another TS in | | | | ● | ∘ |
| the network | | | | | |

● a change in this data triggers the processing of the network change defined in column 1.
∘ this data is used for further processing of the network change defined in column 1.

A change in the Transport Stream loop

The receiver inspects the transport stream (TS) loop of the new version of NIT/actual to detect changes in the transport streams delivered by the network. The following changes are identified:
1. A transport stream is added to the network when the TS loop describes a transport stream that is not known by the list of installed services in the receiver. The receiver 140 may schedule a partial scan for the new transport stream to determine the best-tuned frequency (using a delivery system descriptor and a frequency list descriptor).
2. A transport stream is deleted from the network when the transport stream is known by the list of installed services in the receiver (and delivered by this network) and this transport stream is not described in the TS loop. Services in the list of installed services in the receiver that are received via the deleted transport stream may be nominated for deletion.
   A change in delivery system descriptor/frequency list descriptor

The receiver 140 inspects the delivery system descriptor and frequency list descriptor to detect changes in the delivery parameters and frequencies of transport streams known by the list of installed services in the receiver.

A transport stream is assigned to one or more new frequencies in the network when the delivery system descriptor or frequency list descriptor is changed. The receiver may schedule a partial scan for the existing transport stream to determine the best-tuned frequency. This can be the frequency with the strongest signal or with a highest reception quality measure.

A change in service list descriptor

The receiver 140 compares all service list descriptors in the new version of NITactual with the list of installed services in the receiver. The following changes are identified:
1. A service 120, 121 is removed from a network when the service_id in the list of installed services is not listed in the set of service list descriptors in the new version of NIT/actual 310. The service may be nominated for deletion in the list of installed services. This means that the service is not physically removed from the list of installed services but is kept so the receiver can keep track of it.
2. A service is added to a network when a new service_id is listed in the set of service list descriptors in the new version of NIT/actual. The service is added to the list of installed services.
3. A service is relocated in a network when an existing service_id is listed in a service list descriptor of another transport stream description in the new version of NIT/actual. The service properties are updated in the list of installed services.
   Assigning preset Numbers 150, 151 to new Services 120, 121

When a logical channel descriptor 320 is present in the new version of NIT/actual 310, the new services that are added to the service list may be automatically assigned to the preset number 150, 151 equal to the logical channel number 122.

When the logical channel number of a new service is already in use by another service in the list of installed services the preset number of the new service is resolved depending on the following situations:
1. The preset number is in use by a service nominated for deletion. The receiver may detach the preset number from the service nominated for deletion and assigns the preset number to the new service.
2. The preset number is in use by an existing service and was manually assigned to this preset number by the end user. The receiver may assign the new service to another preset number in a manufacturer dependent way.
3. The preset number is in use by an existing service from another network. Since no new version of NIT/actual of the other network is available the receiver is likely not able to resolve this immediately. The receiver may assign a (temporary) preset number to the new service. Only after the receiver is tuned to the other network (user selects another service) the receiver can resolve this based on the current version of NIT/actual of the other network:
   a. When the other network is not using the logical channel number anymore the new service may be moved from the temporary preset number to the preset number equal to the logical channel number.
   b. When the other network is still using the logical channel number and refers to the identical service as the newly added service (same service id's) then the receiver may arbitrate which one of the services will have a preset number assigned (making duplicate services invisible to the end user).
   c. When the other network is still using the logical channel number and refers to a service different from the newly added service (different service id's) the services may be regional variants. The receiver may arbitrate which one of the services will be assigned to the preset number equal to the logical channel number. The other service will be assigned to another preset number in a manufacturer dependent way. The other service will be assigned to another preset number in a manufacturer dependent way.
      Note 1: The preset number conflict can also occur in more than 2 networks. In those cases all involved networks should be inspected to resolve the conflict.
      Note 2: Arbitration which service will be assigned to the preset number equal to the logical channel descriptor is manufacturer dependent. A possible arbitration method is to select the service with the best reception quality.

When no logical channel descriptor 320 is present in the new version of NIT/actual, new services are assigned to free preset numbers in a manufacturer specific way.

A special case: A service moves to another Network

When the receiver, tuned to a specific network, has no access to actual updates in other networks (the tuned network does for example not deliver NIT/other) then a move of a service to another network can be detected in two sequential updates. The order of detecting the two individual updates is arbitrary but has some influence on how the receiver can react.

When a service moves from the tuned network to another network the new version of NIT/actual will indicate that the service is deleted from the network. There is no information about the destination of the service until the receiver is tuned to the other network that now contains the moved service. The NIT/actual will indicate that the service is added to the network.

When a service moves from another network to the tuned network the new version of NIT/actual will indicate that a service is added to the network. The receiver may notice that the added service is a duplicate and arbitrates which one is assigned to a preset number. When the user selects this service the receiver can already locate the new location of the service without the need to know that the service was moved.

Therefore it is desired that a linkage descriptor 350 may be used to indicate a service move to another network.

A change in Logical channel Descriptor 320

When the logical channel descriptor 320 in the new version of NIT/actual 310 indicates that existing services 120, 121 are rearranged to other preset numbers 150, 151, the receiver 140 may update the list of installed services 120, 121 accordingly. Conflicts may be handled in the same way as described above. Preset numbers of existing services may be reassigned prior to assigning preset numbers to new services in order to avoid conflicts with new services as much as possible.

When the receiver has scheduled a Partial scan for a Transport Stream

When a partial scan is necessary to find the best-tuned frequency of a transport stream this partial scan may be started when:
1. The user tunes to a transport stream that needs a partial scan (by service selection). The partial scan may be done for this transport stream only.
2. When the user switches the receiver in standby mode. The partial scan may be done for every transport stream that needs a partial scan.

During a partial scan the receiver may tune to all frequencies specified in the terrestrial delivery system descriptor and the frequency list descriptor from the last known NIT/actual. The frequency with the best reception quality may be set as the best-tuned frequency.

When no transport stream is received at all the partial scan may be repeated every time the user selects the transport stream.

The user Tunes to a Service

When the user tunes to a service 120, 121 by selecting a preset number 151, 152 the receiver 140 may first tune to the transport stream that delivers the specified service 120, 121 and then select the service. Two specific situations in this process may trigger the automatic service update installation function.

When a Transport stream cannot be Tuned

When the user tunes to a transport stream and the tuner cannot lock on the transport stream at the specified frequency or when a signal loss is detected the receiver may perform a partial scan to recover the required transport stream.

When a partial scan cannot recover the required transport stream, the receiver may attempt to tune to another transport stream in the same network. When this succeeds the NIT/actual may be inspected to detect network changes. When no network changes are detected the receiver may inform the user that the selected service is temporary unavailable. When network changes are detected the receiver may update the list of installed services.

An Alternative method to relocate a Transport stream after a Frequency Change.

When the network transmitters have been reconfigured to other frequencies, a partial scan using the old frequencies may have no result. To prevent the need for a full service installation the broadcaster may advertise the new transmitter frequencies in a next version of NITactual 310 during the last period before the transmitter reconfiguration. A receiver may store the next version of NITactual in memory and may use the new frequencies during a partial scan to find the best-tuned frequency in the new transmitter configuration.

When the Selected service 120, 121 is not Available

When the user selects a service from the installed service list and the receiver detects that the service is (or becomes) not available the receiver may try a number of alternatives to tune the same service or a substitute service.

The first alternative is to find the same service (same service_id) in the list of installed services.

The second alternative is to find a service in the list of installed services with an identical logical channel number.

When no alternative is found, the user may be informed that the service is not available.

The receiver is Switched to Standby

Regular Full Scans

It is desirable to perform regular full frequency scans (e.g. in standby mode, at least once a week) to enhance the ability to detect new networks.

Another descriptor is proposed with which a broadcaster may announce major network changes that require a full scan.

Subject: Implementation of Signalling for Automatic service update Features.

Automatic service update Descriptor

The automatic_service_update_descriptor 340 may be carried in the first loop of NIT 310.

TABLE 1
Automatic service update descriptor

| Syntax | No. of bits | Identifier |
|---|---|---|
| automatic_service_update_descriptor( ){ | | |
| descriptor_tag | 8 | uimsbf |
| descriptor_length | 8 | uimsbf |
| service_list_enable_flag | 1 | bslbf |
| partial_scan_flag | 1 | bslbf |
| SDTother_flag | 1 | bslbf |
| reserved_for_future_use | 5 | bslbf |
| } | | |

Semantics for the Automatic service update Descriptor

service_list_enable_flag: This 1-bit field indicates whether the automatic service update function of the receiver can use the information in the service_list_descriptor carried in NIT/actual to update the user service list. If set to “1”, the receiver may be able to rely on the information carried in the service_list_descriptors in the second loop of NIT/actual. If set to “0”, the receiver may check the SDT/actual before any service updates are processed in the user service list.

Note 1: When service_list_enable_flag is set to “1” the NIT may carry a complete service_list_descriptor for every transport stream of the network

Note 2: Even if the service_list_descriptors in NIT/actual contain a complete list of services, SDT checking may be required. For example when not every service can be received in all geographical areas covered by the network, the SDT/actual may carry this information in the service_availability_descriptor.

partial_scan_flag: This 1 -bit field indicates whether automatic service update function of the receiver can perform a partial scan based on the frequency_list_descriptors in the second loop of NIT/actual. If set to “1”, a partial scan can be performed. If set to “0”, a partial scan is not recommended.

Note: When partial_scan_flag is set to “1” the NIT may specify the full list of alternative frequencies for each transport stream of the network.

SDTother_flag: This 1-bit field indicates whether the automatic service update function of the receiver can use the SDT/other tables to update the service list. If set to “1”, the SDT/other tables can be used to update the service list. If set to “0”, the use of 25 SDT/other is not recommended to automatically update the service list.

Note: Use of SDT/other may increase the performance of the automatic service update function. For a proper functioning the information in SDT/other should be complete for every transport stream in the network. Each SDT/other should contain the same information as SDT/actual of the corresponding transport stream.

Linkage type 350 to Identify moved Services

A new linkage type “service move” may be defined for the linkage descriptor. Linkage descriptors of this type may be carried in the first loop of the NIT 310.

The “service move” linkage type 350 can be used to signal the move of a specific service to another network. Additionally a service move within the same network can be signalled in case no service_list_descriptor/frequency_list_descriptor is carried in the second loop of NIT and no SDT/other is available.

TABLE 2
Automatic service update descriptor

| Syntax | No. of bits | Identifier |
|---|---|---|
| linkage_descriptor( ){ | | |
| <addition to existing linkage descriptor syntax> | | |
| if (linkage_type == “service move”){ | | |
| service_move_type | 8 | uimsbf |
| network_id | 16 | uimsbf |
| network_descriptors_length | 8 | uimsbf |
| for (i=0; i<N;i++){ | | |
| descriptor( ) | | |
| } | | |
| } | | |
| } | | |

Semantics for linkage type “Service Move”

service_move_type: This is an 8-bit field specifying the type of service move:

TABLE 3
Service move type coding

| service_move_type | Description |
|---|---|
| 0x01 | Service moved to another network |
| 0x02 | Service moved within this network |
| 0x03 | Service moved to a new network (see note) |
| 0x04 to 0xFF | reserved for future use |

Note: When a new network is introduced, existing services are not necessarily moved to this new network. It is also possible that the new network only introduces new services. In this case the service_id field in the linkage_descriptor may refer to a service not yet known by the receiver.

network_id: This 16-bit field identifies the Network that is delivering the service.

The following descriptors can be used in the descriptor loop of a “service move” linkage:

terrestrial_delivery_system_descriptor
frequency_list_descriptor
   The combination of these two descriptors specifies all possible frequencies where the service can be located.
   LCN Reserved Range Descriptor

The LCN_reserved_range_descriptor 360 may be carried in the first loop of NIT 310.

TABLE 4
LCN reserved range descriptor

| Syntax | No. of bits | Identifier |
|---|---|---|
| LCN_reserved_range_descriptor( ){ | | |
| descriptor_tag | 8 | uimsbf |
| descriptor_length | 8 | uimsbf |
| range_type | 8 | uimsbf |
| lowest_preset_number | 10 | uimsbf |
| highest_preset_number | 10 | uimsbf |
| reserved | 4 | bslbf |
| } | | |

Semantics for the LCN reserved range descriptor

range_type: This is an 8 -bit field specifying the type of the range:

TABLE 5
range type coding

| range_type | Description |
|---|---|
| 0x01 | range for services not allocatable on specified LCN |
| 0x02 | range for receiver equipment specific services |
| 0x03 | range for radio services |
| 0x04 | range for other broadcast services |
| 0x05 to 0xFF | reserved for future use |

lowest_preset_number: The lowest value of the range of preset numbers 151, 152 used to allocate duplicate services 120, 121. Value may be in the range 1 till 999.
lowest_preset_number: The highest value of the range of preset numbers used to allocate duplicate services. Value may be in the range 1 till 999.

The range_type indicates how the range is to be applied by the receiver 140. If the preset number suggested by the LCN 320 of a service 120, 121 is already occupied at a receiver 140, the receiver is instructed to assign the service to a preset number 151, 152 in the range specified for which the range_type equals 0×01.

Receiver equipment specific services may be services that are local to the receiver, like a gaming service.

A receiver may use a separate list of preset numbers for radio services and for tv services. To avoid a single number referring to both a radio service and a tv service, the range specified with range_type 0×03 may be used for assigning preset numbers to radio services.

It is noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. A system (100) for distributing a signal (110) carrying a plurality of services (120, 121), the system (100) comprising:
a transmitter (130) for generating numbering information (122) pertaining to the plurality of services, for including the numbering information (122) into the signal (110), and for transmitting the signal,
a receiver (140) for receiving the signal (110), for retrieving the numbering information (122) from the signal (110), and for numbering services (120, 121) of the plurality of services in dependence of the numbering information (122).

2. A system (100) as claimed in claim 1, characterized in that the numbering information (122) pertains to a history of the plurality of services (120, 121).

3. A system (100) as claimed in claim 1, characterized in that the numbering information (122) pertains to a modification of a service out of the plurality of services (120, 121).

4. A system (100) as claimed in claim 3, characterized in that the modification comprises a frequency modification, a transport stream modification and/or a network modification.

5. A system (100) as claimed in claim 1, characterized in that the numbering information (122) pertains to a change in the transmitting.

6. A transmitter (130) for use in a system as claimed in claim 1.

7. A receiver (140) for use in a system as claimed in claim 1.

8. A receiver (140) as claimed in claim 7, characterized in that the receiver is arranged for numbering services of the plurality of services (120, 121) in dependence on a reception quality.

9. A receiver (140) as claimed in claim 7, characterized in that the receiver is arranged for numbering services of the plurality of services (120, 121) in dependence on a history of the plurality of services (120, 121).

10. A receiver (140) as claimed in claim 7, characterized in that the receiver is arranged for numbering services of the plurality of services (120, 121) in response to an event.

11. A signal (110) for use in a system as claimed in claim 1, the signal (110) comprising a representation of the numbering information (122).

12. A computer program product enabling a programmable device when executing the computer program product to function as a receiver (140) as defined in claim 7.

13. A method (200) for distributing a signal (110) carrying a plurality of services, (120, 121) the method comprising:
(210) generating numbering information (123) pertaining to the plurality of services (120, 121);
(220) including the numbering information (123) into the signal (110);
(230) transmitting the signal (110);
(240) receiving the signal (110);
(250) retrieving the numbering information (123) from the signal (110); and
(260) numbering services of the plurality of services (120, 121) in dependence of the numbering information (123).

14. A method for transmitting a signal (110) carrying a plurality of services, (120, 121) the method comprising:
(210) generating numbering information (123) pertaining to the plurality of services (120, 121);
(220) including the numbering information (123) into the signal (110); and
(230) transmitting the signal (110.

15. A method for receiving a signal (110) carrying a plurality of services, (120, 121) the method comprising:
(240) receiving the signal (110);
(250) retrieving the numbering information (123) from the signal (110); and
(260) numbering services of the plurality of services (120, 121) in dependence of the numbering information (123).
